(19) United States
(12) Patent Application Publication
(10) Pub. No.: US 2013/0227197 A1
(43) Pub. Date: Aug. 29, 2013

(54) MULTIPLE PRE-DRIVER LOGIC FOR IO HIGH SPEED INTERFACES

(71) Applicant: Lakhdar Iguelmamene, San Jose, CA (US)

(72) Inventor: Lakhdar Iguelmamene, San Jose, CA (US)

(73) Assignee: SanDisk Technologies Inc., Plano, TX (US)

(21) Appl. No.: 13/408,638

(22) Filed: Feb. 29, 2012

(51) Int. Cl. G06F 12/00

(52) U.S. Cl. 711/103; 711/E12.008

(57) ABSTRACT

A memory system or flash card may include a controller interface for communicating with a host. The interface utilizes multiple pre-driver logic blocks that are tolerant to different voltages. For example, one block may use gate oxide devices tolerant to IO low voltage that speed up the delay path during low voltage operation, while a second block may use gate oxide devices tolerant to IO higher voltage for backwards compatibility with devices that operate at a high IO voltage. This allows the interface to take advantage of the IO low voltage device speed for multi-purpose IO use, while still being used for both low voltage and higher voltage protocols.

### TECHNICAL FIELD

This application relates generally to interfaces in memory devices. More specifically, this application relates to improving performance and compatibility of input/output (IO) interfaces between a memory device and a host.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. The host device may communicate with the flash memory through input/output (IO) interfaces from the flash memory controller. An interface for data transfer between integrated circuit devices may include a clock signal from the host device which is used by the flash memory to output data to the host. The timing of the data output from the flash memory may depend on the arrival of the clock signal.

The IO voltage may vary at the interface depending on a desired transfer speed and desired backwards compatibility. For example, a lower IO voltage interface and thinner IO gate oxide devices may provide higher transfer speeds, but may incur substantial changes to the interface that may cause reliability and compatibility problems. Devices designed for higher voltages (e.g. thicker gates) may be slow if a low voltage is applied, while thinner gates may not be compatible with older type cards because they are tolerant to high voltages.

### SUMMARY

It may be desirable to have an interface that utilizes thinner input/output (IO) gate oxide devices with a lower IO voltage interface that maintains compatibility at higher voltage levels. IO pre-driver logic may be split into multiple blocks that are tolerant to different voltages. For example, one block may use gate oxide devices tolerant to IO low voltage (e.g. 1.8V) that speed up the delay path during low voltage operation, while a second block may use gate oxide devices tolerant to IO higher voltage (e.g. 3.3V) for backwards compatibility for high IO voltage operation. This allows the interface to take advantage of the IO low voltage device speed for multi-purpose IO use, while still being used for both low voltage and higher voltage protocols. In other words, devices designed for lower voltage may be used for improved speed, but additional devices may be used in parallel for high voltages.

According to a first aspect, a memory system includes a non-volatile storage having an array of memory blocks storing data and a controller having a processor in communication with the blocks. The controller includes a first input/output (IO) pre-driver logic that is configured for a first voltage and a second IO pre-driver logic that is configured for a second voltage. The processor is configured to provide a signal for selecting between the first voltage and the second voltage.

According to a second aspect, a method is disclosed for interfacing with a host device in a non-volatile storage device having a controller and blocks of memory. The controller is configured for receiving a clock signal from the host device, processing the clock signal with clock pre-driver logic, and generating at least two paths with data pre-driver logic. The at least two paths are configured for different voltage levels.

According to a third aspect, a memory device comprises a non-volatile storage having an array of memory blocks storing data and a controller having a processor in communication with the non-volatile storage. The controller includes an interface circuit that is used for communications between the controller and a host device and includes a clock pre-driver logic that receives a clock signal and a data pre-driver logic that provides a data signal. The controller includes data pre-driver logic that comprises a first input/output (IO) pre-driver logic and is configured for a first voltage and a second IO pre-driver logic configured for a second voltage.

### BRIEF DESCRIPTION OF THE DRAWINGS

FIG. 1 is a block diagram of a host connected with a memory system having non-volatile memory.

FIG. 2 is a block diagram of an exemplary flash memory system controller for use in the system of FIG. 1.

FIG. 3 is a block diagram of a host interface circuit.

FIG. 4 is a block diagram of clock interface circuitry.

FIG. 5 is a block diagram of one embodiment of data interface circuitry.

FIG. 6 is a block diagram of another embodiment of data interface circuitry.

FIG. 7 is a block diagram of another embodiment of a host interface circuit.

### BRIEF DESCRIPTION OF THE PRESENTLY PREFERRED EMBODIMENTS

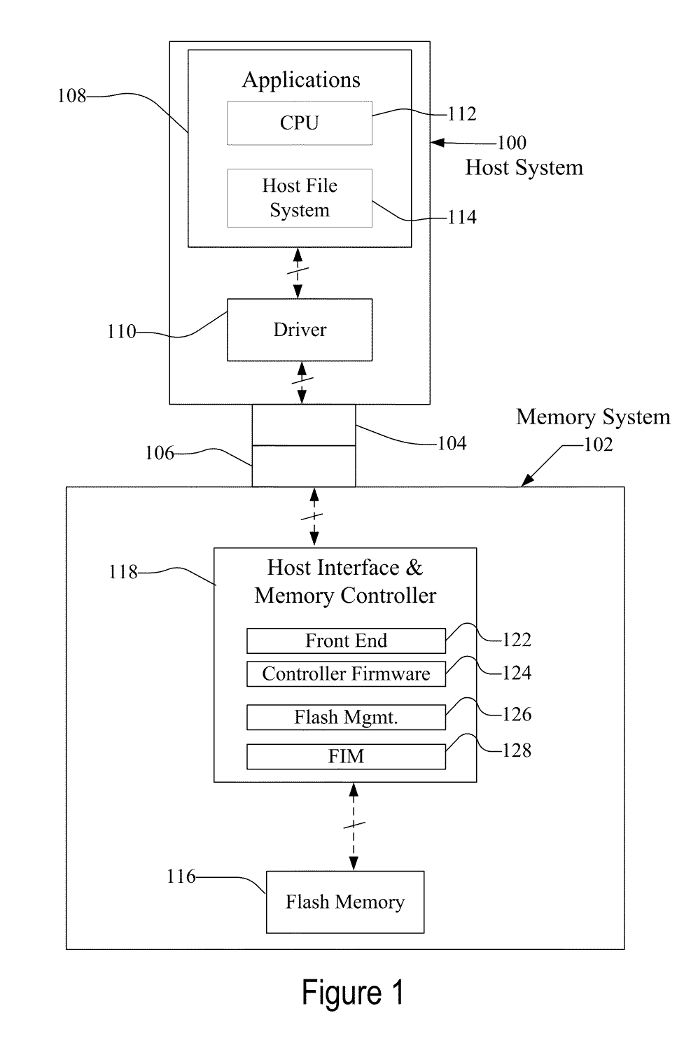

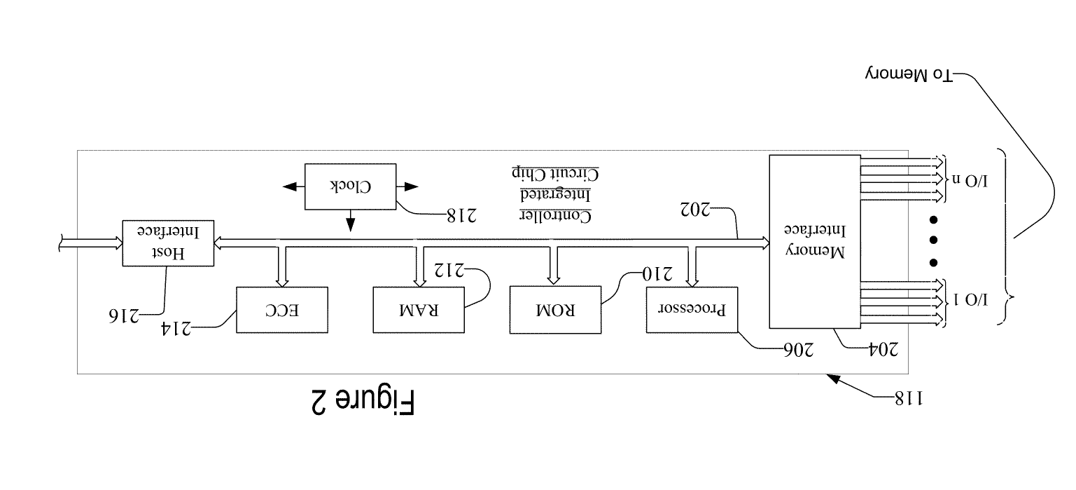

A flash memory system suitable for use in implementing aspects of the invention is shown in FIGS. 1-2. A host system 100 of FIG. 1 stores data into and retrieves data from a flash memory 102. The flash memory may be embedded within the host, such as in the form of a solid state disk (SSD) drive installed in a personal computer. Alternatively, the memory 102 may be in the form of a flash memory card that is removably connected to the host through mating parts 104 and 106 of a mechanical and electrical connector as illustrated in FIG. 1. A flash memory configured for use as an internal or embedded SSD drive may look similar to the schematic of FIG. 1, with one difference being the location of the memory system 102 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 100 of FIG. 1 may be viewed as having two major parts, insofar as the memory 102 is concerned, made up of a combination of circuitry and software. They are an applications portion 108 and a driver portion 110 that interfaces with the memory 102. There may be a central processing unit (CPU) 112 implemented in circuitry and a host file system 114 implemented in hardware. In a PC, for example, the applications portion 108 may include a processor 112 running word processing, graphics, control or other popular application software. In a camera, cellular telephone or other host system 114 that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host 100 to which the memory system 102 is connected for passing data back and forth and controls the memory 116. The system controller 118 may convert between logical addresses of data used by the host 100 and physical addresses of the flash memory 116 during data programming and reading. Functionally, the system controller 118 may include a front end 122 that interfaces with the host system, controller logic 124 for coordinating operation of the memory 116, flash management logic 126 for internal memory management operations such as garbage collection, and one or more flash interface modules (FIMs) 128 to provide a communication interface between the controller with the flash memory 116.

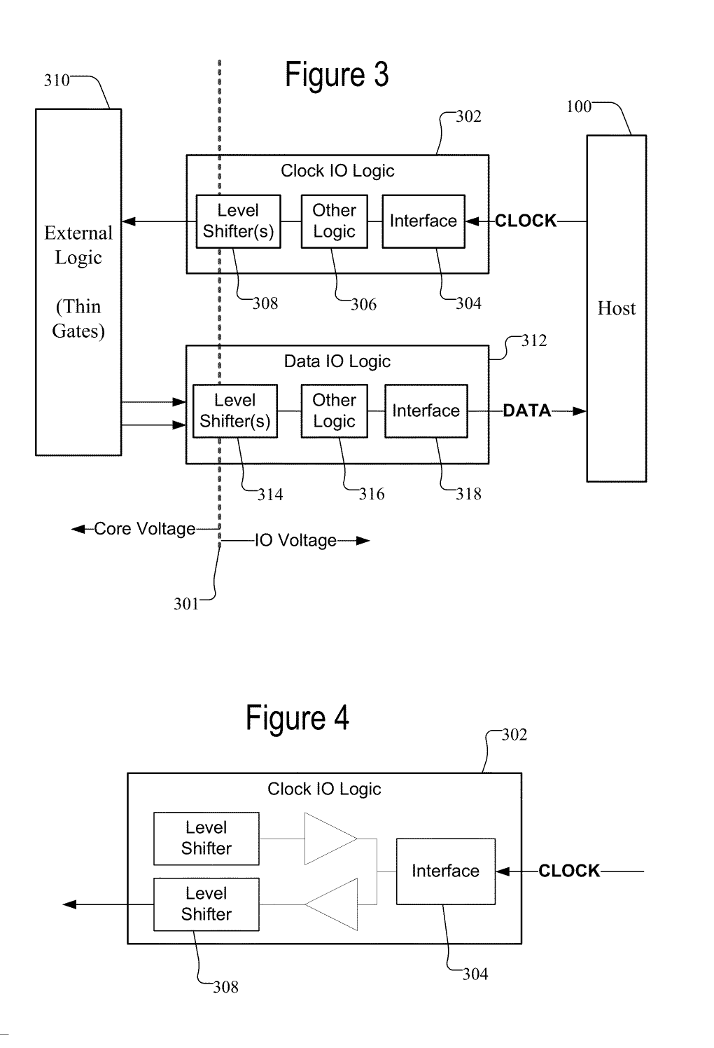

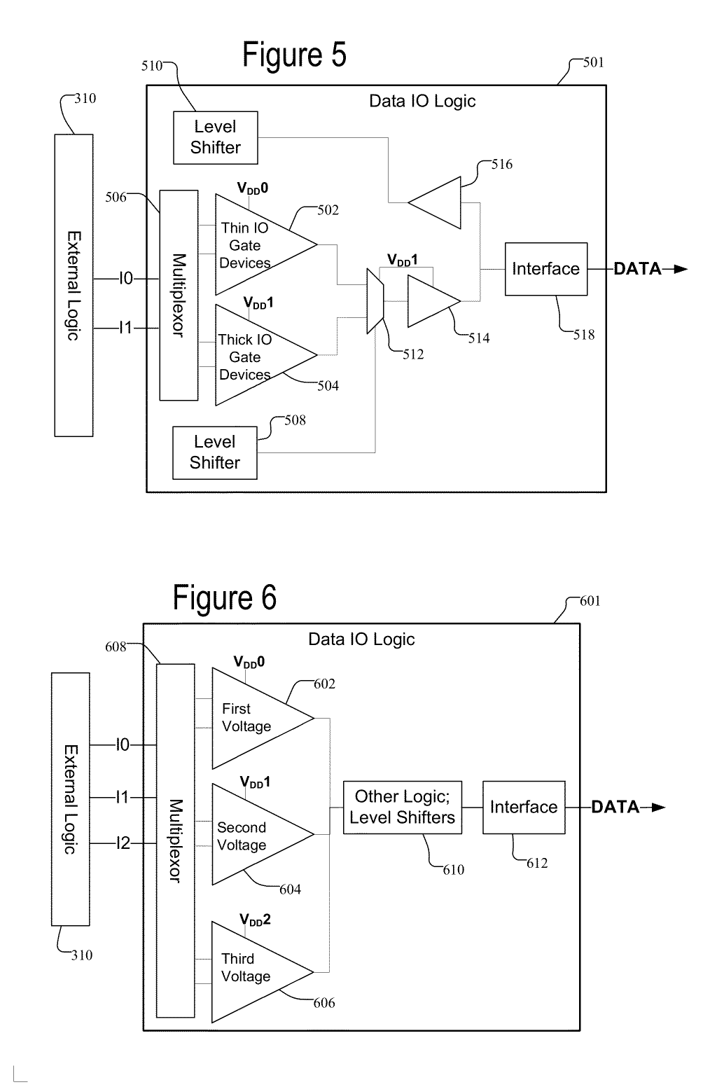

FIG. 2 illustrates a controller integrated circuit chip that is the system controller 118. In particular, the system controller 118 may be implemented on a single integrated circuit chip, such as an application specific integrated circuit (ASIC) such as shown in FIG. 2. The processor 206 of the system controller 118 may be configured as a multi-thread processor capable of communicating via a memory interface 204 having I/O ports for each memory bank in the flash memory 116. The system controller 118 may include an internal clock 218. Alternatively, the host may transmit a clock signal through a host interface 216 to the system controller 118. The host interface 216 may transmit and/or receive data signals to/from the host. The processor 206 communicates with an error correction code (ECC) module 214, a RAM buffer 212, the host interface 216, and ROM 210 via an internal data bus 202. The ROM 210 may be used to initialize a memory system 102, such as a flash memory device. The memory system 102 that is initialized may be referred to as a card. The ROM 210 may be a region of read only memory whose purpose is to provide boot code to the RAM for processing a program, such as the initialization and booting of the memory system 102. The ROM may be present in the ASIC rather than the flash memory chip. The system controller 118, and specifically, the host interface 216, may include the circuits illustrated in FIGS. 3-7. In particular, the data IO logic illustrated in FIG. 5 may be part of the host interface 216.

FIG. 3 is a block diagram of a host interface circuit. FIG. 3 illustrates an interface between a memory device controller (e.g. the system controller 118) and a host device 100. For example, the host interface 216 shown in FIG. 2 is part of the system controller 118 and interfaces between a memory device and a host, such as the host 100. An interface for the purpose of data transfer between integrated circuit devices may include a clock signal provided by the host device 100 which is used by the slave device (e.g. memory device) to output data to the host (e.g. during a read cycle). The timing of the data output from the slave may be dependent on the arrival of the clock signal from the host device 100.

A clock signal transmitted by the host 100 is submitted to the clock IO logic 302. The clock IO logic 302 may be referred to as clock logic, clock IO cell, clock pre-driver logic, or clock IO pre-driver logic, and is further described with respect to FIG. 4. As described, pre-driver logic may refer to the logic stage before the driver circuit stage. The clock IO logic 302 may include an interface 304 that receives the clock signal from the host 100. There may be other logic 306 within the clock IO logic 302 that includes or interacts with one or more level shifters 308. One example of the other logic 306 and the level shifters 308 is shown in FIG. 4. The level shifters 308 may change the voltage level of signals to the external logic 310. The external logic 310 may comprise thin gates and be optimized for lower voltages for improved performance. Accordingly, the external logic 310 may require a lower voltage signal, such as a signal at a core voltage. The core may include devices with very low thickness.

The voltage level 301 illustrates that the external logic 310 or core may operate at a core voltage level because the core devices are thin, while the logic to the right of the external logic 310 may be at a higher voltage, such as the IO voltage. In other embodiments, the external logic 310 may include circuitry that is optimized for low voltages, as well as circuitry for high voltages to maintain backwards compatibility. Level shifters may be necessary because the IO voltage may vary (e.g. 1.8V and 3.3V) for the same interface protocol and the core logic (e.g. external logic 310) on modern processes (0.13 um and below) may run at lower voltages (e.g. 1.2V or 1.0V).

The data IO logic 312 may be referred to as data logic, data IO cell, data pre-driver logic, or data IO pre-driver logic, and is further described with respect to FIGS. 5 and 6. The data IO logic 312 may receive one or more signals from the external logic 310. In single data rate (SDR) devices, there may be a single signal and in double data rate (DDR) devices, there may be two signals. In other embodiments, there may be more data signals. As with the clock IO logic, the data IO logic 312 may include one or more level shifters 314 that shift from the core voltage from the external logic 310 to the IO voltage as illustrated by the voltage levels 301. Along with one or more level shifters 314, the data IO logic 312 may include other logic 316, and an interface 318. Exemplary other logic 316 may be further illustrated with respect to FIG. 5. The interface 318 may communicate one or more data signals with the host 100.

When higher transfer speeds are desired, an interface protocol may lower the IO voltage interface and use thinner IO gate oxide devices. However, the use of such gates may result in substantial changes to the interface (e.g. addition of signal pins and backward compatibility for higher IO voltage). A higher IO voltage operation may cause reliability problems. In the examples of SD UHS, MMC 4.4, or other protocols, the interface data transfer rates may increase from prior versions of the protocol, but a lower IO voltage interface was not adopted and backward compatibility may be necessary. Accordingly, the device side ASIC may be designed to handle the different voltages as described. In particular, FIGS. 5 and 6 illustrate data IO logic circuitry for handling the different voltages. The use of thick gate oxide devices in the IO voltage domain may consume delay internal to the ASIC device. Increasing the drive-strength for the output IO cell may increase the amount of overshoot and undershoot seen by the host device, which may cause functional failures.

FIG. 4 is a block diagram of clock interface circuitry. In particular, FIG. 4 illustrates one embodiment of the clock IO logic 302. As shown, the interface 304 receives a clock signal. There are two level shifters 308, one of which transmits a level-shifted signal to the external logic 310 as shown in FIG. 3. The level shifters 308 operate to submit low voltage signals to the external logic 310 which may include thin gates and may be set at the core voltage as shown by the voltage shift 301 in FIG. 3. The circuitry of the clock IO logic 302 may vary from FIG. 4.

FIG. 5 is a block diagram of one embodiment of data interface circuitry. The data IO logic 501 may be a circuit that is a DATA IO cell. The data IO logic 501 may receive two signals IO and Il from the external logic 310 and provides data signals to the host device through the interface 518. FIG. 5 illustrates that the IO pre-driver logic is split into two blocks with the same last driver logic. In particular, the data IO logic 501 may include two data IO pre-drivers, block 502 power with lower IO voltage in this case (e.g. 1.8V) and block 504 powered with high IO voltage in this case (e.g. 3.3V). The data IO pre-drivers 502, 504 may be referred to as data logic, data IO logic, data pre-driver logic or IO logic. In one embodiment, the first pre-driver block 502 uses a gate oxide device tolerant to IO low voltage (e.g. 1.8V) which may speed up the delay path during low voltage operation. The second pre-driver block 504 uses a gate oxide device tolerant to IO higher voltage (e.g. 3.3V), which may improve backward compatibility for high IO voltage operation. In other words, block 502 includes thin IO gate devices, while block 504 includes thicker IO gate devices. Accordingly, the input voltages for the pre-driver blocks are different. V_{DD}0 and V_{DD}1 may be different power supplies that may correspond with the input signals I0 and I1, respectively. V_{DD}0 may have a lower voltage than V_{DD}1.

The inputs from the external logic 310 may first pass through a multiplexor 506, which flexes between signals I0 and I1. The outputs from the pre-driver logic blocks 502, 504 are multiplexed by multiplexor 512 to drive the last stage of the driver through additional pre-driver logic 514 to the interface 518. FIG. 5 illustrates two level shifters 508, 510 for shifting between voltage levels. A last stage driver 516 communicates with the interface 518. During IO low voltage operation the last stage driver 516 voltage may be switched to low voltage level to maintain the IO operation. In alternate embodiments, the additional logic and level shifters may be arranged differently with the IO pre-driver logic split into blocks for handling different voltages.

The split of the IO pre-driver logic as in FIG. 5 may take advantage of a IO low voltage device speed for multi-purpose IO use. The IO may then be used for both low voltage (e.g. 1.8V) and higher voltage (e.g. 3.3V) protocols. The low voltage pre-driver path (block 502) may be fast since it uses the right gate oxide device for low voltage purpose which may optimize the IO low voltage protocol.

The path for this circuit is divided into two paths that can maximize the use of thinner IO devices during low voltage operation and maintain backwards compatibility with high voltage IO devices. There may be a signal from the memory controller to disable the switching between block 502 and block 504 to allow for the selection between the blocks. The signal from the memory controller for selecting the path (low or high voltage) through either block 502 or block 504 may be referred to as a MUX_EN signal (not shown) and may be provided to the multiplexor 506 from the memory controller. In particular, the signal from the controller to the multiplexor 506 may determine which path is taken by establishing the voltage. In the example of FIG. 6, the signal from the controller to the multiplexor 506 may select from three different paths.

FIG. 6 is a block diagram of another embodiment of data interface circuitry. Data IO logic 601 may be similar to data IO logic 501 of FIG. 5, except there are three IO pre-driver logic blocks 602, 604, 606 rather than two in FIG. 5. In alternative embodiments, there may be more than two IO pre-driver logic blocks or data input pre-driver blocks that correspond to different voltage values. In FIG. 6, block 602 corresponds with a first voltage level from a first power supply V_{DD}0, block 604 corresponds with a second voltage level from a second power supply V_{DD}1, and block 606 corresponds with a third voltage level from a third power supply V_{DD}2. The external logic 310 may pass three signals I0, I1, and I2 into a multiplexor 608 that provides a signal for each of the logic blocks 602, 604, 606. There may be other logic including level shifters 610 within the data IO logic 601. The interface 612 provides the data signal to the host.

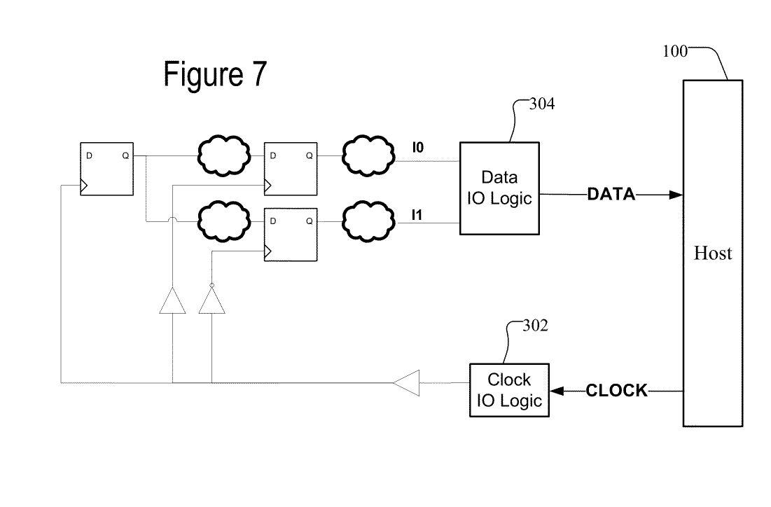

FIG. 7 is a block diagram of another embodiment of a host interface circuit. FIG. 7 illustrates exemplary external logic 310 from FIG. 3. The external logic receives a clock signal from the clock pre-drive logic 302 and provides one or more data signals to the data pre-driver logic 304. The clock signal is sent from the host 100, which receives the data signal.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

I claim:

1. A memory system comprising:
a non-volatile storage having an array of memory blocks storing data;
a controller having a processor in communication with the blocks;
the controller further comprising:
a first input/output (IO) pre-driver logic configured for a first voltage; and
a second IO pre-driver logic configured for a second voltage;
wherein the processor is configured to provide a signal for selecting between the first voltage and the second voltage.

2. The system of claim 1 wherein the first IO pre-driver logic and the second IO pre-driver logic provide alternate paths for signal processing.

3. The system of claim 2 wherein the first IO pre-driver logic comprises thin gate oxide devices tolerant to a lower voltage and the second IO pre-driver logic comprises thick gate oxide devices tolerant to a higher voltage.

4. The system of claim 2 further comprising a multiplexor coupled with the first IO pre-driver logic and the second IO pre-driver logic, wherein a signal for selecting between the first voltage and the second voltage selects the path for the signal processing, further wherein the signal is communicated by the processor to the multiplexor.

5. The system of claim 4 wherein the path utilizing the first IO pre-driver logic is for lower voltages and improves processing speed

6. The system of claim 1 wherein the first IO pre-driver logic and the second IO pre-driver logic are part of a data IO logic that provides a data signal to the host.

7. The system of claim 6 further comprising an interface in the data IO logic that communicates the data signal to the host.

8. The system of claim 6 further comprising a clock IO logic that receives a clock signal from the host.

9. The system of claim 8 further comprising external logic that receives the clock signal and generates the data signal, wherein the data IO logic and the clock IO logic each comprise one or more level shifters for shifting voltage levels.

10. The system of claim 9 wherein the external logic comprises thin gate oxide devices tolerant to a lower voltage, wherein the first voltage comprises the lower voltage and the second voltage comprises a higher voltage.

11. A method for interfacing with a host device comprising:
in a non-volatile storage device having a controller and blocks of memory, the controller:
receives a clock signal from the host device;
processes the clock signal with clock IO logic; and
generates at least two paths with data IO logic, wherein the at least two paths are configured for different voltage levels.

12. The method of claim 11 further comprising:
transmitting a signal to select one of the at least two paths for signal processing.

13. The method of claim 12 wherein the selection of the path is based on a voltage level for the signal processing.

14. The method of claim 13 wherein the at least two paths comprise thin gate oxide devices tolerant to a lower voltage in one path and thick gate oxide devices tolerant to a higher voltage in another path.

15. The method of claim 14 wherein the path with the thin gate oxide devices is selected for devices operating at a lower voltage for improved speed, and the path with the thick gate oxide devices is selected for devices operating at a higher voltage.

16. The method of claim 13 wherein the at least two paths comprise a first IO pre-driver logic in one path and a second IO pre-driver logic in another path.

17. The method of claim 11 wherein the data IO logic provides a data signal to the host device.

18. A memory device comprising:
a non-volatile storage having an array of memory blocks storing data;
a controller having a processor in communication with the non-volatile storage; and
the controller having an interface circuit for communications between the controller and a host device, wherein the interface comprises:
clock IO logic that receives a clock signal; and
data IO logic that provides a data signal, wherein the data pre-driver logic comprises a first input/output (IO) pre-driver logic configured for a first voltage and a second IO pre-driver logic configured for a second voltage.

19. The memory device of claim 18 wherein the first IO pre-driver logic and the second IO pre-driver logic provide alternate paths for signal processing.

20. The memory device of claim 19 wherein the first IO pre-driver logic comprises thin gate oxide devices tolerant to a lower voltage and the second IO pre-driver logic comprises thick gate oxide devices tolerant to a higher voltage, wherein the path utilizing the first IO pre-driver logic is for lower voltages and improves processing speed and the path with the thick gate oxide devices is selected for devices operating at a higher voltage.
